(19) United States
(12) Patent Application Publication
(10) Pub. No.: US 2014/0097989 A1
(43) Pub. Date: Apr. 10, 2014

(54) PLATE ANTENNA MODULE AND METHOD OF MANUFACTURING THE SAME

(71) Applicant: INPAQ TECHNOLOGY CO., LTD., Miaoli County (TW)

(72) Inventors: TA-FU CHENG, MIAOLI COUNTY (TW); CHIH-MING SU, TAIPEI CITY (TW); YUAN PIAO TSENG, HSINCHU CITY (TW); CHIA-SHUI CHANG, TAICHUNG CITY (TW)

(73) Assignee: INPAQ TECHNOLOGY CO., LTD., MIAOLI COUNTY (TW)

(21) Appl. No.: 13/645,442

(22) Filed: Oct. 4, 2012

(51) Int. Cl. H01Q 1/38; H01P 11/00

(52) U.S. Cl. 343/700 MS; 29/600

(57) ABSTRACT

A plate antenna module includes a first substrate unit, a second substrate unit, an adhesive unit and a pin unit. The first substrate unit including a first substrate body and a first electrode layer disposed on the top side of the first substrate body. The second substrate unit including a second substrate body disposed on the bottom side of the first substrate body, and the second substrate body has a second dielectric constant different from the first dielectric constant of the first substrate body. The adhesive unit includes a first adhesive sheet adhesively disposed between the first substrate body and the second substrate body and a second adhesive sheet adhered to the bottom side of the second substrate body. The pin unit includes a feeding pin electrically contacting the first electrode layer and sequentially passing through the first substrate unit, the second substrate unit and the adhesive unit.

### BACKGROUND OF THE INVENTION

1. Field of the Invention

The instant disclosure relates to a plate antenna module and a method of manufacturing the same, and more particularly to a plate antenna module and a method of manufacturing the same using a low dielectric constant substrate for decreasing the dielectric constant of the plate antenna module.

2. Description of Related Art

With the development of wireless communication technologies, wireless transmission technologies are widely used in mobile information media or personal data management tools. For example, electronic products, such as notebook computers and so on, usually need to transmit/receive data to/from other data devices. Based on wireless transmission technologies, many structures can be simplifies and many connecting wires can be avoided. To achieve the above-mentioned wireless transmission, conventional electronic products must have antennae, and most of the electronic products have inbuilt antenna devices for wireless communication.

### SUMMARY OF THE INVENTION

One aspect of the instant disclosure relates to a plate antenna module and a method of manufacturing the same using a low dielectric constant substrate for decreasing the dielectric constant of the plate antenna module.

One of the embodiments of the instant disclosure provides a plate antenna module, comprising: a first substrate unit, a second substrate unit, an adhesive unit and a pin unit. The first substrate unit including a first substrate body and a first electrode layer disposed on the top side of the first substrate body, wherein the first substrate body has a first dielectric constant. The second substrate unit including a second substrate body disposed on the bottom side of the first substrate body, wherein the second substrate body has a second dielectric constant different from the first dielectric constant of the first substrate body. The adhesive unit includes at least one first adhesive sheet adhesively disposed between the bottom side of the first substrate body and the top side of the second substrate body and at least one second adhesive sheet adhered to the bottom side of the second substrate body, wherein the at least one first adhesive sheet has a first uniform thickness and the at least one second adhesive sheet has a second uniform thickness. The pin unit includes at least one feeding pin electrically contacting the first electrode layer and sequentially passing through the first substrate unit, the second substrate unit and the adhesive unit.

Another one of the embodiments of the instant disclosure provides a method of manufacturing a plate antenna module, comprising: providing a first substrate body, wherein the first substrate body has a first dielectric constant; forming a first electrode layer on the top side of the first substrate body; adhesively placing at least one first adhesive sheet on the bottom side of the first substrate body, wherein the at least one first adhesive sheet has a first uniform thickness; placing a second substrate body on the at least one first adhesive sheet, wherein the at least one first adhesive sheet is adhesively disposed between the bottom side of the first substrate body and the top side of the second substrate body, and the second substrate body has a second dielectric constant different from the first dielectric constant of the first substrate body; adhesively placing at least one second adhesive sheet on the bottom side of the second substrate body, wherein the at least one second adhesive sheet has a second uniform thickness; and sequentially passing through the first electrode layer, the first substrate body, the at least one first adhesive sheet, the second substrate body and the at least one second adhesive sheet by at least one feeding pin, wherein the at least one feeding pin electrically contacts the first electrode layer.

Yet another one of the embodiments of the instant disclosure provides a method of manufacturing a plate antenna module, comprising: providing a first substrate body, wherein the first substrate body has a first dielectric constant; forming a first electrode layer on the top side of the first substrate body; sequentially passing through the first electrode layer and the first substrate body by at least one feeding pin, wherein the at least one feeding pin electrically contacts the first electrode layer; adhesively placing at least one first adhesive sheet on the bottom side of the first substrate body, wherein the at least one first adhesive sheet has a first uniform thickness, and the at least one first adhesive sheet is passed by the at least one feeding pin; placing a second substrate body on the at least one first adhesive sheet, wherein the at least one first adhesive sheet is adhesively disposed between the bottom side of the first substrate body and the top side of the second substrate body, the second substrate body has a second dielectric constant different from the first dielectric constant of the first substrate body, and the second substrate body is passed by the at least one feeding pin; and adhesively placing at least one second adhesive sheet on the bottom side of the second substrate body, wherein the at least one second adhesive sheet has a second uniform thickness, and the at least one second adhesive sheet is passed by the at least one feeding pin.

More precisely, when the second dielectric constant of the second substrate body is smaller than the first dielectric constant of the first substrate body, the ratio of the second dielectric constant to the first dielectric constant is substantially 1:1.1˜10.

More precisely, when the second dielectric constant of the second substrate body is larger than the first dielectric constant of the first substrate body, the ratio of the second dielectric constant to the first dielectric constant is substantially 10˜1.1:1.

More precisely, the first substrate body has a first uniform thickness, the second substrate body has a second uniform thickness, and the second uniform thickness of the second substrate body is different from the first uniform thickness of the first substrate body.

More precisely, the at least one feeding pin has a protrusion portion exposedly disposed on the top side of the first electrode layer, an embedded portion extended downwardly from the protrusion portion and embedded in the first substrate unit, the second substrate unit and the adhesive unit, and a pin portion extended downwardly from the embedded portion and exposed from the second substrate body.

More precisely, the first substrate unit includes at least one first substrate through hole concurrently passing through the first substrate body and the first electrode layer, the second substrate unit includes at least one second substrate through hole passing through the second substrate body, the adhesive unit includes at least one first sheet through hole passing through the at least one first adhesive sheet and at least one second sheet through hole passing through the at least one second adhesive sheet, and the at least one feeding pin sequentially passes through the at least one first substrate through hole, the at least one first sheet through hole, the at least one second substrate through hole and the at least one second sheet through hole.

More precisely, the second substrate unit includes a second electrode layer disposed between the bottom side of the second substrate body and the at least one second adhesive sheet, and the at least one feeding pin and the second electrode layer are separated from each other, wherein the first substrate unit includes at least one first substrate through hole concurrently passing through the first substrate body and the first electrode layer, the second substrate unit includes at least one second substrate through hole concurrently passing through the second substrate body and the second electrode layer, the adhesive unit includes at least one first sheet through hole passing through the at least one first adhesive sheet and at least one second sheet through hole passing through the at least one second adhesive sheet, and the at least one feeding pin sequentially passes through the at least one first substrate through hole, the at least one first sheet through hole, the at least one second substrate through hole and the at least one second sheet through hole.

Therefore, the second dielectric constant of the second substrate body is different from the first dielectric constant of the first substrate body (i.e., the second dielectric constant of the second substrate body may be smaller or larger than the first dielectric constant of the first substrate body), and the at least one first adhesive sheet is adhesively disposed between the bottom side of the first substrate body and the top side of the second substrate body, thus the dielectric constant of the plate antenna module can be adjusted or decreased and both the gain value and the axial ratio of the plate antenna module can be increased.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1A shows a perspective, exploded, schematic view of the plate antenna module according to the first embodiment of the instant disclosure;

FIG. 1B shows a perspective, assembled, schematic view of the plate antenna module according to the first embodiment of the instant disclosure;

FIG. 1C shows a lateral, schematic view of the plate antenna module according to the first embodiment of the instant disclosure;

FIG. 1D shows a flowchart of a method of manufacturing the plate antenna module according to the first embodiment of the instant disclosure;

FIG. 1E shows a flowchart of another method of manufacturing the plate antenna module according to the first embodiment of the instant disclosure;

FIG. 2A shows a perspective, exploded, schematic view of the plate antenna module according to the second embodiment of the instant disclosure;

FIG. 2B shows a perspective, assembled, schematic view of the plate antenna module according to the second embodiment of the instant disclosure;

FIG. 2C shows a lateral, schematic view of the plate antenna module according to the second embodiment of the instant disclosure;

FIG. 3 shows a lateral, schematic view of the plate antenna module according to the third embodiment of the instant disclosure; and

FIG. 4 shows a lateral, schematic view of the plate antenna module according to the fourth embodiment of the instant disclosure.

### DETAILED DESCRIPTION OF THE PREFERRED EMBODIMENTS

### First Embodiment

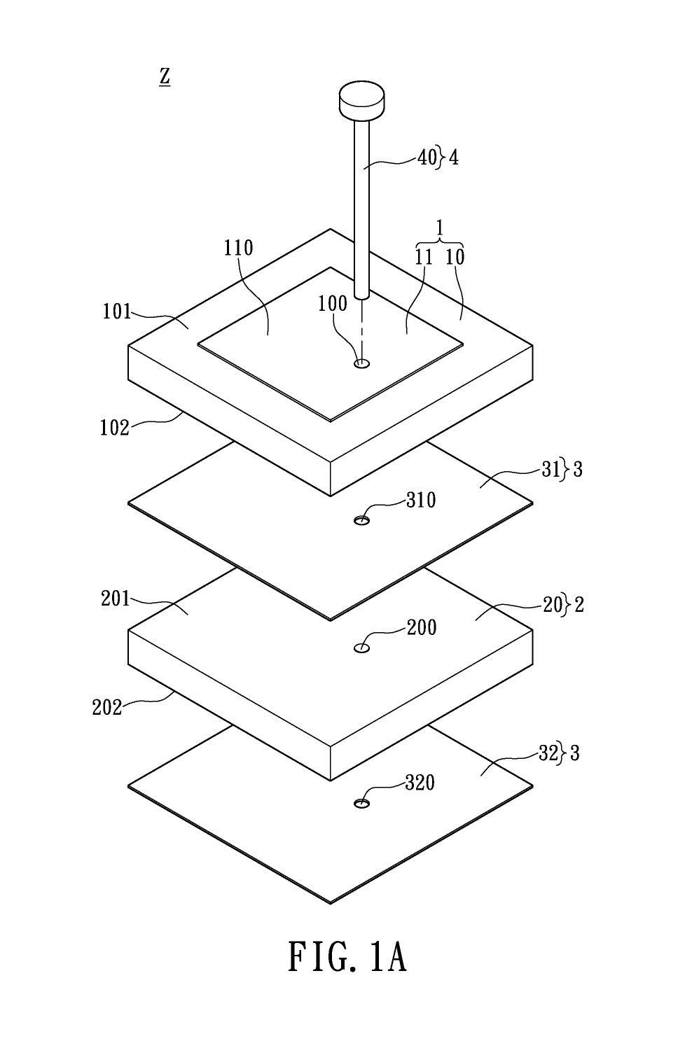

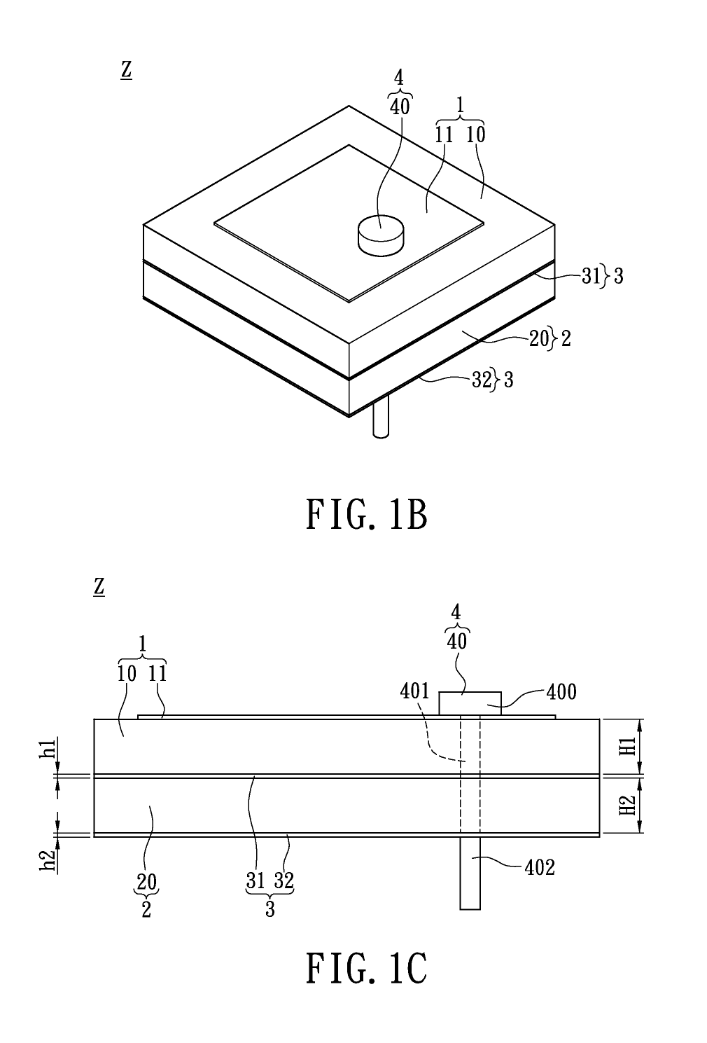

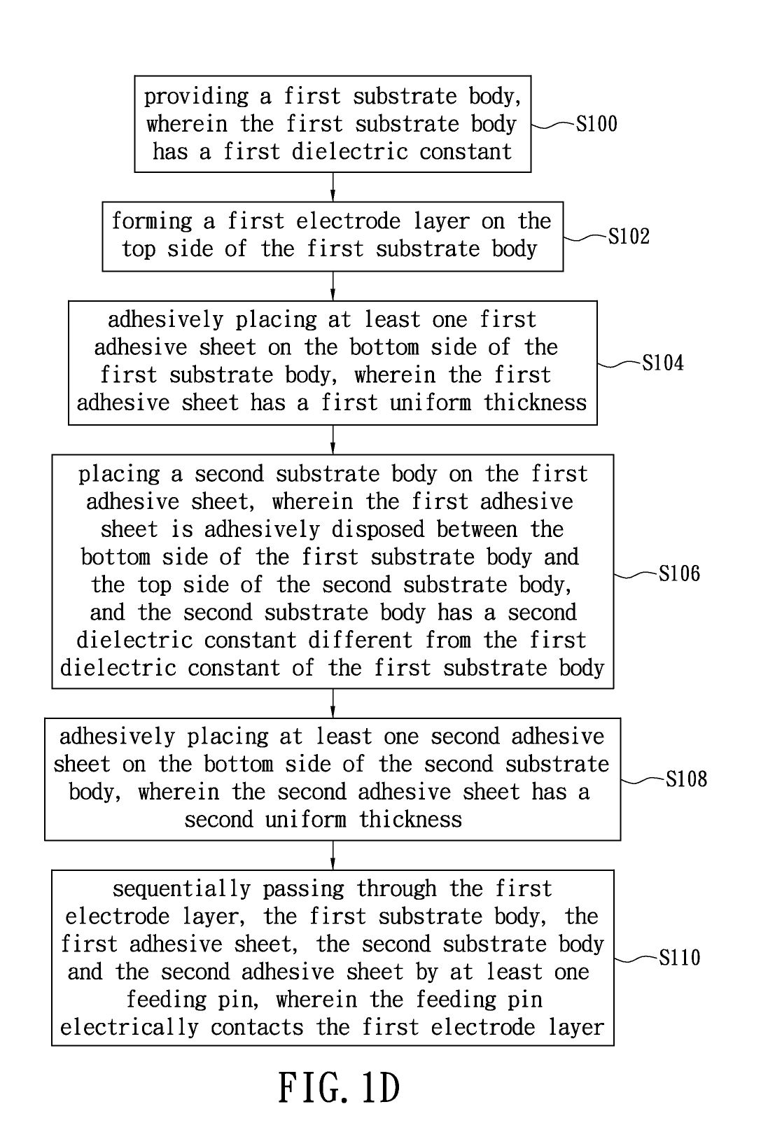

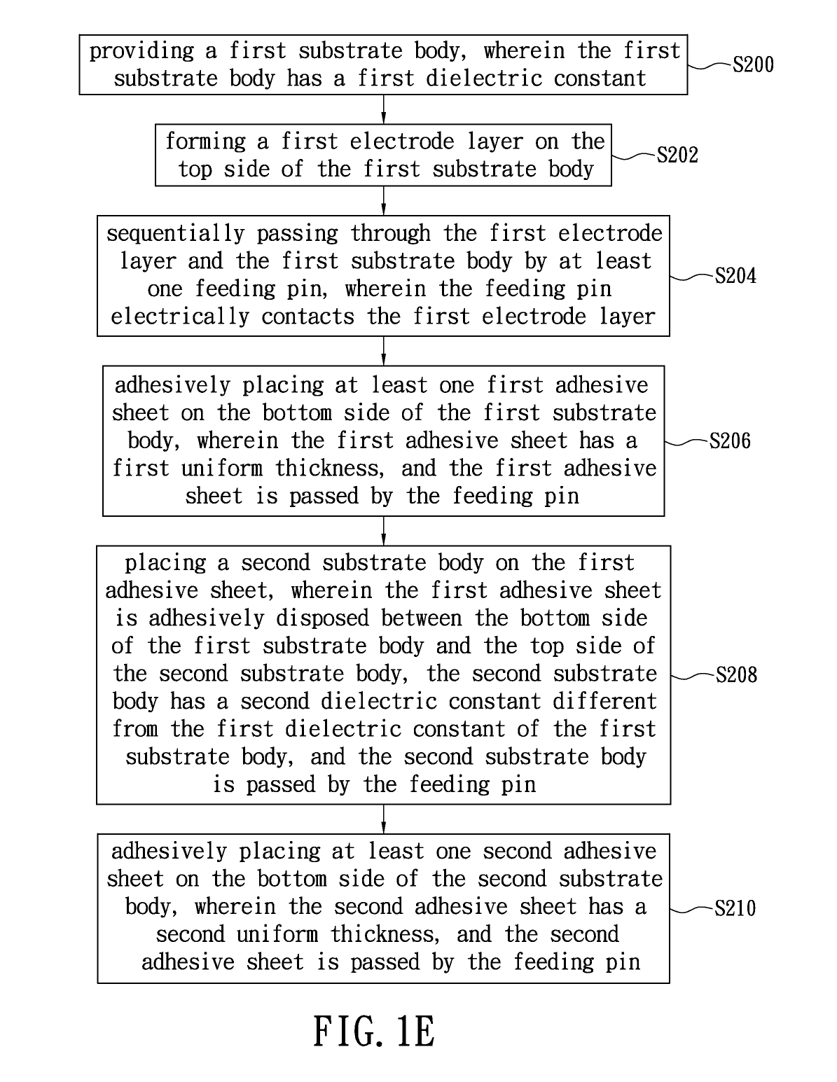

Referring to FIG. 1A to FIG. 1C, where the first embodiment of the instant disclosure provides a plate antenna module Z, comprising: a first substrate unit 1, a second substrate unit 2, an adhesive unit 3 and a pin unit 4.

First, the first substrate unit 1 includes a first substrate body 10 and a first electrode layer 11 disposed on the top side 101 of the first substrate body 10, and the second substrate unit 2 includes a second substrate body 20 disposed on the bottom side 102 of the first substrate body 10. In addition, the first substrate body 10 has a first dielectric constant, and the second substrate body 20 has a second dielectric constant different from the first dielectric constant of the first substrate body 10 (i.e., the second dielectric constant of the second substrate body 20 may be smaller or larger than the first dielectric constant of the first substrate body 10). For example, the first substrate body 10 may be a ceramic substrate having a first dielectric constant (such as k=8), the second substrate body 20 may be any type of substrate having a second dielectric constant (such as k=3.3) smaller than the first dielectric constant of the ceramic substrate.

More precisely, when the second dielectric constant of the second substrate body 20 is smaller than the first dielectric constant of the first substrate body 10, the ratio of the second dielectric constant to the first dielectric constant is substantially 1:1.1˜10. When the second dielectric constant of the second substrate body 20 is larger than the first dielectric constant of the first substrate body 10, the ratio of the second dielectric constant to the first dielectric constant is substantially 10˜1.1:1. Hence, the first dielectric constant of the first substrate body 10 and the second dielectric constant of the second substrate body 20 can be adjusted to change the ratio between the first dielectric constant and the second dielectric constant according to different requirements. Moreover, the first substrate body 10 has a first uniform thickness H1, the second substrate body 20 has a second uniform thickness H2, and the second uniform thickness H2 of the second substrate body 20 is different from the first uniform thickness H1 of the first substrate body 10 (i.e., the second uniform thickness H2 of the second substrate body 20 may be smaller or larger than the first uniform thickness H1 of the first substrate body 10), thus the first uniform thickness H1 of the first substrate body 10 and the second uniform thickness H2 of the second substrate body 20 can be adjusted to change the ratio between the first dielectric constant and the second dielectric constant according to different requirements.

Furthermore, the adhesive unit 3 includes at least one first adhesive sheet 31 adhesively disposed between the bottom side 102 of the first substrate body 10 and the top side 201 of the second substrate body 20 and at least one second adhesive sheet 32 adhered to the bottom side 202 of the second substrate body 20, and the at least one first adhesive sheet 31 has a first uniform thickness h1 and the at least one second adhesive sheet 32 has a second uniform thickness h2. More precisely, the second substrate body 20 can be disposed on the bottom side 102 of the first substrate body 10 through the at least one first adhesive sheet 31, and the second substrate body 20 can be disposed on a main circuit board (not shown) through the at least one second adhesive sheet 32. In other words, the second substrate body 20 can be horizontally disposed on the bottom side 102 of the first substrate body 10 through the at least one first adhesive sheet 31, and the second substrate body 20 can be horizontally disposed on the main circuit board (not shown) through the at least one second adhesive sheet 32, thus the stabilization of the electrical property of the plate antenna module Z can be increased effectively.

Moreover, the pin unit 4 includes at least one feeding pin 40 electrically contacting the first electrode layer 11 and sequentially passing through the first substrate unit 1, the second substrate unit 2 and the adhesive unit 3. For example, the at least one feeding pin 40 has a protrusion portion 400 exposedly disposed on the top side 110 of the first electrode layer 11, an embedded portion 401 extended downwardly from the protrusion portion 400 and embedded in the first substrate unit 1, the second substrate unit 2 and the adhesive unit 3, and a pin portion 402 extended downwardly from the embedded portion 401 and exposed from the second substrate body 20.

More precisely, the first substrate unit 1 includes at least one first substrate through hole 100 concurrently passing through the first substrate body 10 and the first electrode layer 11, the second substrate unit 2 includes at least one second substrate through hole 200 passing through the second substrate body 20, the adhesive unit 3 includes at least one first sheet through hole 310 passing through the at least one first adhesive sheet 31 and at least one second sheet through hole 320 passing through the at least one second adhesive sheet 32, and the at least one feeding pin 40 can sequentially pass through the at least one first substrate through hole 100, the at least one first sheet through hole 310, the at least one second substrate through hole 200 and the at least one second sheet through hole 320.

Referring to FIG. 1D, the first embodiment of the instant disclosure provides a method of manufacturing a plate antenna module, comprising: providing a first substrate body 10, wherein the first substrate body 10 has a first dielectric constant (S100); forming a first electrode layer 11 on the top side 101 of the first substrate body 10 (S102); adhesively placing at least one first adhesive sheet 31 on the bottom side 102 of the first substrate body 10, wherein the at least one first adhesive sheet 31 has a first uniform thickness h1 (S104); placing a second substrate body 20 on the at least one first adhesive sheet 31, wherein the at least one first adhesive sheet 31 is adhesively disposed between the bottom side 102 of the first substrate body 10 and the top side 201 of the second substrate body 20, and the second substrate body 20 has a second dielectric constant different from the first dielectric constant of the first substrate body 10 (S106); adhesively placing at least one second adhesive sheet 32 on the bottom side 202 of the second substrate body 20, wherein the at least one second adhesive sheet 32 has a second uniform thickness h2 (S108); and then sequentially passing through the first electrode layer 11, the first substrate body 10, the at least one first adhesive sheet 31, the second substrate body 20 and the at least one second adhesive sheet 32 by at least one feeding pin 40, wherein the at least one feeding pin 40 electrically contacts the first electrode layer 11 (S110).

Referring to FIG. 1E, the first embodiment of the instant disclosure provides another method of manufacturing a plate antenna module, comprising: providing a first substrate body 10, wherein the first substrate body 10 has a first dielectric constant (S200); forming a first electrode layer 11 on the top side 101 of the first substrate body 10 (S202); sequentially passing through the first electrode layer 11 and the first substrate body 10 by at least one feeding pin 40, wherein the at least one feeding pin 40 electrically contacts the first electrode layer 11 (S204); adhesively placing at least one first adhesive sheet 31 on the bottom side 102 of the first substrate body 10, wherein the at least one first adhesive sheet 31 has a first uniform thickness h1, and the at least one first adhesive sheet 31 is passed by the at least one feeding pin 40 (S206); placing a second substrate body 20 on the at least one first adhesive sheet 31, wherein the at least one first adhesive sheet 31 is adhesively disposed between the bottom side 102 of the first substrate body 10 and the top side 201 of the second substrate body 20, the second substrate body 20 has a second dielectric constant different from the first dielectric constant of the first substrate body 10, and the second substrate body 20 is passed by the at least one feeding pin 40 (S208); and then adhesively placing at least one second adhesive sheet 32 on the bottom side 202 of the second substrate body 20, wherein the at least one second adhesive sheet 32 has a second uniform thickness h2, and the at least one second adhesive sheet 32 is passed by the at least one feeding pin 40 (S210).

### Second Embodiment

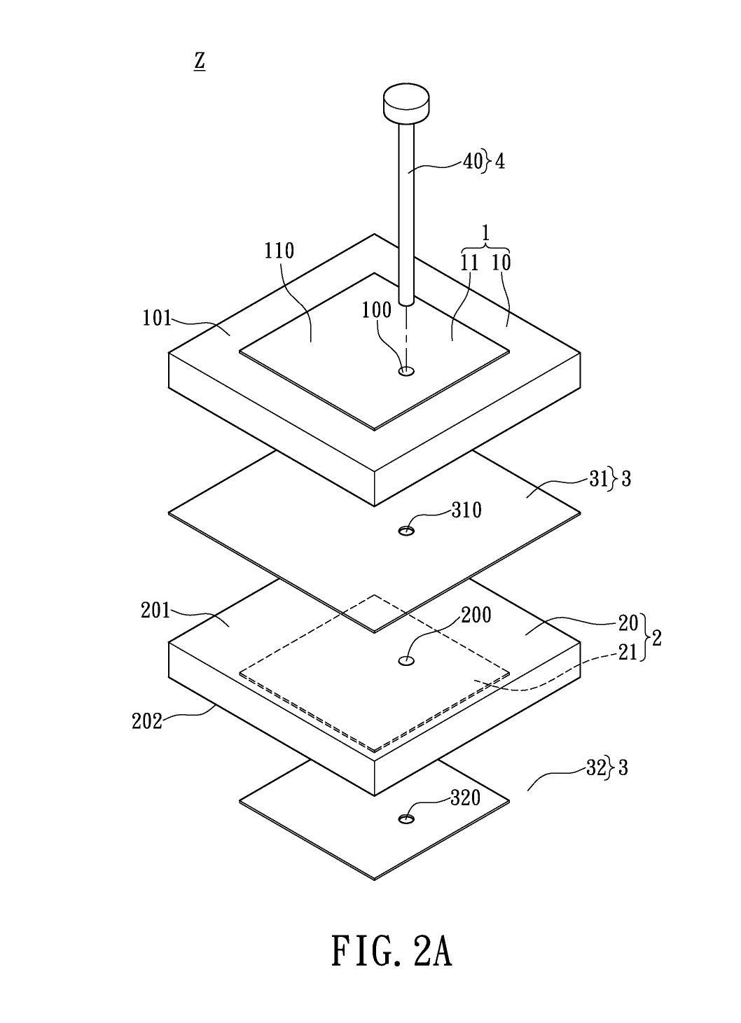

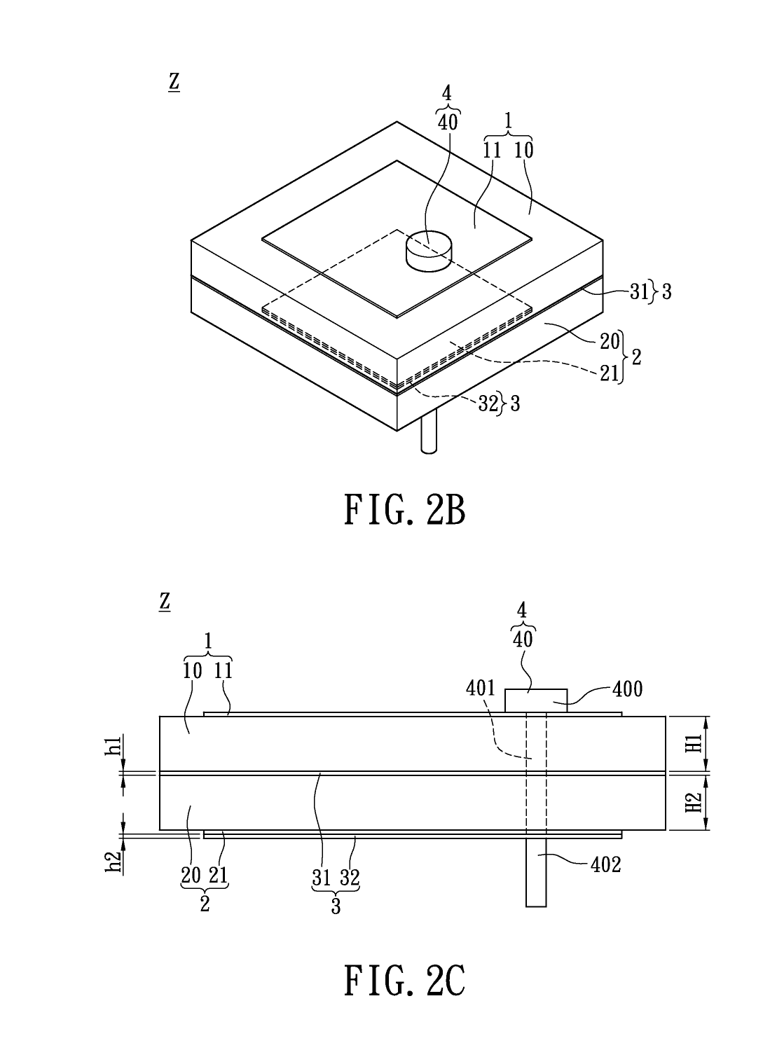

Referring to FIG. 2A to FIG. 2C, where the second embodiment of the instant disclosure provides a plate antenna module Z, comprising: a first substrate unit 1, a second substrate unit 2, an adhesive unit 3 and a pin unit 4. The difference between the second embodiment and the first embodiment is as follows: in the second embodiment, the second substrate unit 2 includes a second electrode layer 21 disposed between the bottom side 202 of the second substrate body 20 and the at least one second adhesive sheet 32, and the at least one feeding pin 40 and the second electrode layer 21 are separated from each other (i.e., the at least one feeding pin 40 cannot touch the second electrode layer 21, thus the at least one feeding pin 40 is insulated from the second electrode layer 21). More precisely, the first substrate unit 1 includes at least one first substrate through hole 100 concurrently passing through the first substrate body 10 and the first electrode layer 11, the second substrate unit 2 includes at least one second substrate through hole 200 concurrently passing through the second substrate body 20 and the second electrode layer 21, the adhesive unit 3 includes at least one first sheet through hole 310 passing through the at least one first adhesive sheet 31 and at least one second sheet through hole 320 passing through the at least one second adhesive sheet 32, and the at least one feeding pin 40 can sequentially pass through the at least one first substrate through hole 100, the at least one first sheet through hole 310, the at least one second substrate through hole 200 and the at least one second sheet through hole 320.

### Third Embodiment

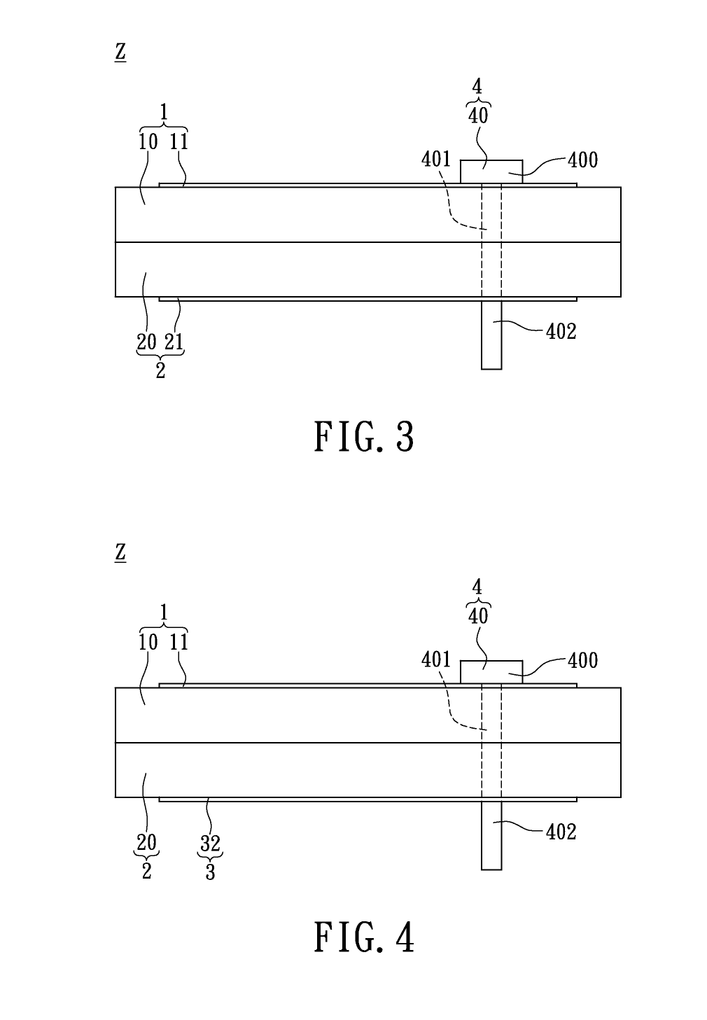

Referring to FIG. 3, where the third embodiment of the instant disclosure provides a plate antenna module Z, comprising: a first substrate unit 1, a second substrate unit 2 and a pin unit 4. The first substrate unit 1 includes a first substrate body 10 and a first electrode layer 11 disposed on the top side 101 of the first substrate body 10, and the second substrate unit 2 includes a second substrate body 20 disposed on the bottom side 102 of the first substrate body 10 and a second electrode layer 21 disposed on the bottom side 202 of the second substrate body 20, and the first substrate 10 and the second substrate body 20 can be combined with each other to form a low-temperature co-fired substrate (such as a LTCC (Low-Temperature Co-fired Ceramic)) by a low-temperature co-fired technology. In addition, the first substrate body 10 has a first dielectric constant, and the second substrate body 20 has a second dielectric constant different from the first dielectric constant of the first substrate body 10 (i.e., the second dielectric constant of the second substrate body 20 may be smaller or larger than the first dielectric constant of the first substrate body 10). Moreover, the pin unit 4 includes at least one feeding pin 40 electrically contacting the first electrode layer 11 and sequentially passing through the first substrate body 10 and the second substrate body 20, and the at least one feeding pin 40 and the second electrode layer 21 are separated from each other (i.e., the at least one feeding pin 40 cannot touch the second electrode layer 21, thus the at least one feeding pin 40 is insulated from the second electrode layer 21). Hence, comparing FIG. 3 with FIG. 2C, the difference between the third embodiment and the second embodiment is as follows: in the third embodiment, the first substrate body 10 and the second substrate body 20 can be combined with each other without using the at least one first adhesive sheet 31 that disposed between the first substrate body 10 and the second substrate body 20 as shown in the second embodiment.

### Fourth Embodiment

Referring to FIG. 4, where the third embodiment of the instant disclosure provides a plate antenna module Z, comprising: a first substrate unit 1, a second substrate unit 2, an adhesive unit 3 and a pin unit 4. The first substrate unit 1 includes a first substrate body 10 and a first electrode layer 11 disposed on the top side 101 of the first substrate body 10, and the second substrate unit 2 includes a second substrate body 20 disposed on the bottom side 102 of the first substrate body 10 and a second electrode layer 21 disposed on the bottom side 202 of the second substrate body 20, and the first substrate 10 and the second substrate body 20 can be combined with each other to form a low-temperature co-fired substrate (such as a LTCC) by a low-temperature co-fired technology. In addition, the first substrate body 10 has a first dielectric constant, and the second substrate body 20 has a second dielectric constant different from the first dielectric constant of the first substrate body 10 (i.e., the second dielectric constant of the second substrate body 20 may be smaller or larger than the first dielectric constant of the first substrate body 10). Moreover, the adhesive unit 3 includes at least one second adhesive sheet 32 adhered to the bottom side 202 of the second substrate body 20. Furthermore, the pin unit 4 includes at least one feeding pin 40 electrically contacting the first electrode layer 11 and sequentially passing through the first substrate body 10 and the second substrate body 20, and the at least one feeding pin 40 and the second electrode layer 21 are separated from each other (i.e., the at least one feeding pin 40 cannot touch the second electrode layer 21, thus the at least one feeding pin 40 is insulated from the second electrode layer 21). Hence, comparing FIG. 4 with FIG. 1C, the difference between the fourth embodiment and the first embodiment is as follows: in the fourth embodiment, the first substrate body 10 and the second substrate body 20 can be combined with each other without using the at least one first adhesive sheet 31 that is disposed between the first substrate body 10 and the second substrate body 20 as shown in the first embodiment.

In conclusion, the second dielectric constant of the second substrate body 20 is different from the first dielectric constant of the first substrate body 10 (i.e., the second dielectric constant of the second substrate body 20 may be smaller or larger than the first dielectric constant of the first substrate body 10), and the at least one first adhesive sheet 31 is adhesively disposed between the bottom side 102 of the first substrate body 10 and the top side 201 of the second substrate body 20, thus the dielectric constant of the plate antenna module Z can be adjusted or decreased and both the gain value and the axial ratio of the plate antenna module Z can be increased. More precisely, when the second dielectric constant is smaller than the first dielectric constant, the ratio of the second dielectric constant to the first dielectric constant is substantially 1:1.1˜10, and when the second dielectric constant is larger than the first dielectric constant, the ratio of the second dielectric constant to the first dielectric constant is substantially 10˜1.1:1, thus the first dielectric constant and the second dielectric constant can be adjusted to change the ratio between the first dielectric constant and the second dielectric constant according to different requirements.

The above-mentioned descriptions merely represent the preferred embodiments of the instant disclosure, without any intention or ability to limit the scope of the instant disclosure which is fully described only within the following claims Various equivalent changes, alterations or modifications based on the claims of instant disclosure are all, consequently, viewed as being embraced by the scope of the instant disclosure.

What is claimed is:

1. A plate antenna module, comprising:
a first substrate unit including a first substrate body and a first electrode layer disposed on the top side of the first substrate body, wherein the first substrate body has a first dielectric constant;
a second substrate unit including a second substrate body disposed on the bottom side of the first substrate body, wherein the second substrate body has a second dielectric constant different from the first dielectric constant of the first substrate body;
an adhesive unit including at least one first adhesive sheet adhesively disposed between the bottom side of the first substrate body and the top side of the second substrate body and at least one second adhesive sheet adhered to the bottom side of the second substrate body, wherein the at least one first adhesive sheet has a first uniform thickness and the at least one second adhesive sheet has a second uniform thickness; and
a pin unit including at least one feeding pin electrically contacting the first electrode layer and sequentially passing through the first substrate unit, the second substrate unit and the adhesive unit.

2. The plate antenna module of claim 1, wherein the second dielectric constant of the second substrate body is smaller than the first dielectric constant of the first substrate body, the ratio of the second dielectric constant to the first dielectric constant is substantially 1:1.1˜10.

3. The plate antenna module of claim 1, wherein the second dielectric constant of the second substrate body is larger than the first dielectric constant of the first substrate body, the ratio of the second dielectric constant to the first dielectric constant is substantially 10˜1.1:1.

4. The plate antenna module of claim 1, wherein the first substrate body has a first uniform thickness, the second substrate body has a second uniform thickness, and the second uniform thickness of the second substrate body is different from the first uniform thickness of the first substrate body.

5. The plate antenna module of claim 1, wherein the at least one feeding pin has a protrusion portion exposedly disposed on the top side of the first electrode layer, an embedded portion extended downwardly from the protrusion portion and embedded in the first substrate unit, the second substrate unit and the adhesive unit, and a pin portion extended downwardly from the embedded portion and exposed from the second substrate body.

6. The plate antenna module of claim 1, wherein the first substrate unit includes at least one first substrate through hole concurrently passing through the first substrate body and the first electrode layer, the second substrate unit includes at least one second substrate through hole passing through the second substrate body, the adhesive unit includes at least one first sheet through hole passing through the at least one first adhesive sheet and at least one second sheet through hole passing through the at least one second adhesive sheet, and the at least one feeding pin sequentially passes through the at least one first substrate through hole, the at least one first sheet through hole, the at least one second substrate through hole and the at least one second sheet through hole.

7. The plate antenna module of claim 1, wherein the second substrate unit includes a second electrode layer disposed between the bottom side of the second substrate body and the at least one second adhesive sheet, and the at least one feeding pin and the second electrode layer are separated from each other, wherein the first substrate unit includes at least one first substrate through hole concurrently passing through the first substrate body and the first electrode layer, the second substrate unit includes at least one second substrate through hole concurrently passing through the second substrate body and the second electrode layer, the adhesive unit includes at least one first sheet through hole passing through the at least one first adhesive sheet and at least one second sheet through hole passing through the at least one second adhesive sheet, and the at least one feeding pin sequentially passes through the at least one first substrate through hole, the at least one first sheet through hole, the at least one second substrate through hole and the at least one second sheet through hole.

8. A method of manufacturing a plate antenna module, comprising:
providing a first substrate body, wherein the first substrate body has a first dielectric constant;
forming a first electrode layer on the top side of the first substrate body;
adhesively placing at least one first adhesive sheet on the bottom side of the first substrate body, wherein the at least one first adhesive sheet has a first uniform thickness;
placing a second substrate body on the at least one first adhesive sheet, wherein the at least one first adhesive sheet is adhesively disposed between the bottom side of the first substrate body and the top side of the second substrate body, and the second substrate body has a second dielectric constant different from the first dielectric constant of the first substrate body;
adhesively placing at least one second adhesive sheet on the bottom side of the second substrate body, wherein the at least one second adhesive sheet has a second uniform thickness; and
sequentially passing through the first electrode layer, the first substrate body, the at least one first adhesive sheet, the second substrate body and the at least one second adhesive sheet by at least one feeding pin, wherein the at least one feeding pin electrically contacts the first electrode layer.

9. The method of claim 8, wherein the first substrate body has a first uniform thickness, the second substrate body has a second uniform thickness, and the second uniform thickness of the second substrate body is different from the first uniform thickness of the first substrate body.

10. The method of claim 8, wherein the at least one feeding pin has a protrusion portion exposedly disposed on the top side of the first electrode layer, an embedded portion extended downwardly from the protrusion portion and embedded in the first substrate unit, the second substrate unit and the adhesive unit, and a pin portion extended downwardly from the embedded portion and exposed from the second substrate body.

11. The method of claim 8, wherein the first substrate unit includes at least one first substrate through hole concurrently passing through the first substrate body and the first electrode layer, the second substrate unit includes at least one second substrate through hole passing through the second substrate body, the adhesive unit includes at least one first sheet through hole passing through the at least one first adhesive sheet and at least one second sheet through hole passing through the at least one second adhesive sheet, and the at least one feeding pin sequentially passes through the at least one first substrate through hole, the at least one first sheet through hole, the at least one second substrate through hole and the at least one second sheet through hole.

12. The method of claim 8, wherein the second substrate unit includes a second electrode layer disposed between the bottom side of the second substrate body and the at least one second adhesive sheet, and the at least one feeding pin and the second electrode layer are separated from each other, wherein the first substrate unit includes at least one first substrate through hole concurrently passing through the first substrate body and the first electrode layer, the second substrate unit includes at least one second substrate through hole concurrently passing through the second substrate body and the second electrode layer, the adhesive unit includes at least one first sheet through hole passing through the at least one first adhesive sheet and at least one second sheet through hole passing through the at least one second adhesive sheet, and the at least one feeding pin sequentially passes through the at least one first substrate through hole, the at least one first sheet through hole, the at least one second substrate through hole and the at least one second sheet through hole.

13. A method of manufacturing a plate antenna module, comprising:
providing a first substrate body, wherein the first substrate body has a first dielectric constant;
forming a first electrode layer on the top side of the first substrate body;
sequentially passing through the first electrode layer and the first substrate body by at least one feeding pin, wherein the at least one feeding pin electrically contacts the first electrode layer;
adhesively placing at least one first adhesive sheet on the bottom side of the first substrate body, wherein the at least one first adhesive sheet has a first uniform thickness, and the at least one first adhesive sheet is passed by the at least one feeding pin;
placing a second substrate body on the at least one first adhesive sheet, wherein the at least one first adhesive sheet is adhesively disposed between the bottom side of the first substrate body and the top side of the second substrate body, the second substrate body has a second dielectric constant different from the first dielectric constant of the first substrate body, and the second substrate body is passed by the at least one feeding pin; and
adhesively placing at least one second adhesive sheet on the bottom side of the second substrate body, wherein the at least one second adhesive sheet has a second uniform thickness, and the at least one second adhesive sheet is passed by the at least one feeding pin.

14. The method of claim 13, wherein the first substrate body has a first uniform thickness, the second substrate body has a second uniform thickness, and the second uniform thickness of the second substrate body is different from the first uniform thickness of the first substrate body.

15. The method of claim 13, wherein the at least one feeding pin has a protrusion portion exposedly disposed on the top side of the first electrode layer, an embedded portion extended downwardly from the protrusion portion and embedded in the first substrate unit, the second substrate unit and the adhesive unit, and a pin portion extended downwardly from the embedded portion and exposed from the second substrate body.

16. The method of claim 13, wherein the first substrate unit includes at least one first substrate through hole concurrently passing through the first substrate body and the first electrode layer, the second substrate unit includes at least one second substrate through hole passing through the second substrate body, the adhesive unit includes at least one first sheet through hole passing through the at least one first adhesive sheet and at least one second sheet through hole passing through the at least one second adhesive sheet, and the at least one feeding pin sequentially passes through the at least one first substrate through hole, the at least one first sheet through hole, the at least one second substrate through hole and the at least one second sheet through hole.

17. The method of claim 13, wherein the second substrate unit includes a second electrode layer disposed between the bottom side of the second substrate body and the at least one second adhesive sheet, and the at least one feeding pin and the second electrode layer are separated from each other, wherein the first substrate unit includes at least one first substrate through hole concurrently passing through the first substrate body and the first electrode layer, the second substrate unit includes at least one second substrate through hole concurrently passing through the second substrate body and the second electrode layer, the adhesive unit includes at least one first sheet through hole passing through the at least one first adhesive sheet and at least one second sheet through hole passing through the at least one second adhesive sheet, and the at least one feeding pin sequentially passes through the at least one first substrate through hole, the at least one first sheet through hole, the at least one second substrate through hole and the at least one second sheet through hole.
